(19) United States
(12) Patent Application Publication
(10) Pub. No.: US 2018/0115091 A1
(43) Pub. Date: Apr. 26, 2018

(54) BATTERY CLAMP AND METHOD FOR MANUFACTURING A BATTERY CLAMP

(71) Applicant: Hella KGaA Hueck & Co., Lippstadt (DE)

(72) Inventors: Katrin Zimmermann, Lippstadt (DE); Marco Unterhalt, Salzkotten (DE)

(21) Appl. No.: 15/566,250

(22) PCT Filed: May 3, 2016
(86) PCT No.: PCT/EP2016/059879

§ 371 Date: Oct. 13, 2017

(30) Foreign Application Priority Data
May 6, 2015 (DE) 10 2015 107 044.8

(51) Int. Cl. H01R 11/28

(52) U.S. Cl. CPC H01R 11/283

(57) ABSTRACT

A battery clamp consists of a punch-bent component on which a holder is formed, which can be applied to a battery pole in an application direction. Fasteners are also provided for clamping the holder onto the pole of the battery. The fasteners can primarily be turned or screwed in in the application direction of the holder. Clamps are also provided that interact with the fasteners to produce the clamping effect of the holder on the pole of the battery. The clamps include a minimum of one clamping element, which is connected to the punch-bent component and/or makes contact with it.

### CROSS REFERENCE

This application claims priority to PCT Patent Application No. PCT/EP2016/059879, filed 3 May 2016, which itself claims priority to German Application No. 10 2015 107044.8, filed 6 May 2015, the entirety of both of which are hereby incorporated by reference.

### FIELD OF THE INVENTION

This invention consists of a battery clamp and a method for manufacturing such a battery clamp.

### BACKGROUND OF THE INVENTION

A battery clamp of the aforementioned type known from EP 1 675 221 A1 is known. The battery clamp described in said document includes a holder that can be pushed onto a pole of a battery as well as fasteners for the clamping and fastening the holder onto the pole of the battery. These fasteners include a screw that can be inserted into a nut, where the screw can be screwed in the application direction of the holder, i.e. in the lengthwise direction of the pole. This direction usually corresponds to the vertical direction, meaning that, for these types of battery clamps, the fastening device is also identified as a vertical screw connection. In the case of EP 1675 221 A 1, the holder is designed using an initial punch-bent component. The battery clamp includes two other punch-bent components, which can be pushed into the first punch-bent component from the side. Through tightening of the screw protruding through the two additional punch-bent components, two limbs of the initial punch-bent component going outward from the holder are moved toward each other, causing the diameter of the holder to be reduced and thus the holder to firmly clamp against the pole.

For this state of technology, the complexity of the battery clamp proves to be disadvantageous. One factor is that the clamp consisting of many individual parts is expensive to manufacture. Another factor is that the wide variety of individual parts results in substantial assembly work.

In addition, battery clamps in punch-bent technology are known from the state of the art of technology, in which the fasteners can be operated or screwed in vertically or horizontally in relation to the application direction of the holder. This design has a disadvantage in that the fasteners are difficult to access.

The problem underlying the invention is the creation of a battery clamp described at the beginning of this document, for which the fasteners are readily accessible but which nevertheless has a comparatively simple structure. Furthermore, a method for manufacturing such as a battery clamp needs to be specified.

### SUMMARY OF THE INVENTION

This is achieved in accordance with invention specifications using a battery clamp of the type described at the beginning of this document with the identifying characteristics of Claim 1 as well as using a method with the characteristics of Claim 15. The subclaims address preferred configurations of the invention.

In accordance with Claim 1, it has been ensured that the clamps include at least one clamping element which is connected to the punch-bent component and/or makes contact with this component. This reduces the complexity of the battery clamp. In particular, it uses only a few additional parts such as fasteners and at least one clamping element, which are sometimes used in forged clamps as well.

Despite the simplicity of the inventive battery clamp, it can be used to implement a vertical screw connection, which guarantees easy access to the fasteners.

In particular, it can be ensured that the battery clamp is designed as a single-part punch-bent component with the exception of the fasteners and the minimum of one clamping element. This greatly reduces the complexity of the battery clamp. The design of the battery clamp as a punch-bent component offers a significant weight advantage in comparison to battery clamps known from the state of the art of technology. Furthermore, an inventive battery clamp allows the complexity of the geometry to be reduced.

There is a chance that the minimum of one clamping element includes an angled surface enclosing an angle not equal to 0° or to 90° relative to the application direction, preferably an angle between 10° and 40° (an angle between 20° and 30° would be ideal). Furthermore, it can be ensured that the fasteners include at least one angled surface enclosing an angle not equal to 0° or to 90° relative to the application direction, preferably an angle between 10° and 40° (an angle between 20° and 30° would be ideal).

For example, the battery clamp here can include two clamping elements, each having an angled surface enclosing an angle not equal to 0° or 90° relative to the application direction, where both clamping elements preferably are arranged on sides facing away from each other and where fasteners can include two angled surfaces enclosing an angle not equal to 0° or 90° relative to the application direction, where both angled surfaces of the fasteners are preferably positioned opposite each other on different sides of the punch-bent component. Preferably, the angled surface of the minimum of one clamping element can make contact with the minimum of one angled surface of the fasteners, interacting with said surface to produce the clamping effect of the holder on the pole of the battery. In this way, despite the complex geometry of the single-part punch-bent component, clamps can be implemented for fastening the holder to the pole of the battery.

The fasteners may include a screw with a head and a threaded section as well as a nut, where the minimum of one angled surface of the fasteners can be positioned against the head of the screw or against the nut. In particular, the minimum of one angled surface is positioned on that fastener component, which does not rotate during the screwing process. When screwing the screw into the nut, this component is the nut. When screwing the nut onto the screw, this component is the head of the screw.

There exists the chance that the holder has been opened or has an opening, particularly in a direction vertical in relation to the application direction, where the punch-bent component has two limbs connected to the opening of the holder and protruding from the holder. Here, the minimum of one clamping element can be positioned against one of the limbs of the punch-bent component, where preferably one clamping element is positioned at each of the two limbs. The interaction between the angled surfaces of the clamping elements and the angled surfaces of the fasteners thus results immediately in the limbs moving toward each other and a resulting clamping effect of the holder against the pole.

There exists the chance that the minimum of one clamping element is permanently attached to one of the limbs of the punch-bent component, in particular through stamping with one of the limbs. This allows for easier assembly of the battery clamp because there are no additional assembly steps required for the minimum of one clamping element.

Furthermore, it can be ensured that the punch-bent component includes at least one holding section for fasteners. In particular, the minimum of one holding section of the punch-bent component can be positioned against one of the limbs. The design ensures that suitable sections of the punch-bent component handle the task of guiding the screw.

There exists the chance that the battery clamp includes a connection section for a cable or a battery sensor, which in particular is included in the punch-bent component design, where the connection section on the side facing away from the limbs preferably protrudes away from the holder, in particular in the direction facing away from the limbs. The connection section can also be integrated into the punch-bent component in this way such that the entire battery clamp can be configured as one part with the exception of the fasteners.

In accordance with Claim 15, it is to be ensured that the minimum of one clamping element is connected to the punch-bent component in the course of being punched and/or bent. For example, a connection between the minimum of one clamping element and the punch-bent component can be implemented in the punching process that is part of the manufacturing process for the punch-bent component. This greatly simplifies the manufacture of the battery clamp.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a side view of an inventive battery clamp.

FIG. 2 shows a top view of the battery clamp in accordance with FIG. 1 without fasteners.

FIG. 3 shows, in contrast to FIG. 1, a side view of the battery clamp rotated by 90°.

FIG. 4 shows a cross section in accordance with the arrows IV-IV in FIG. 2.

FIG. 5 shows a top view of the punch-bent component of an inventive battery clamp after punching and before bending.

FIG. 6 shows the punch-bent component in accordance with FIG. 5 after bending.

### DETAILED DESCRIPTION OF THE DRAWINGS

In the figures, identical components or components with identical functions have been given the same reference numbers.

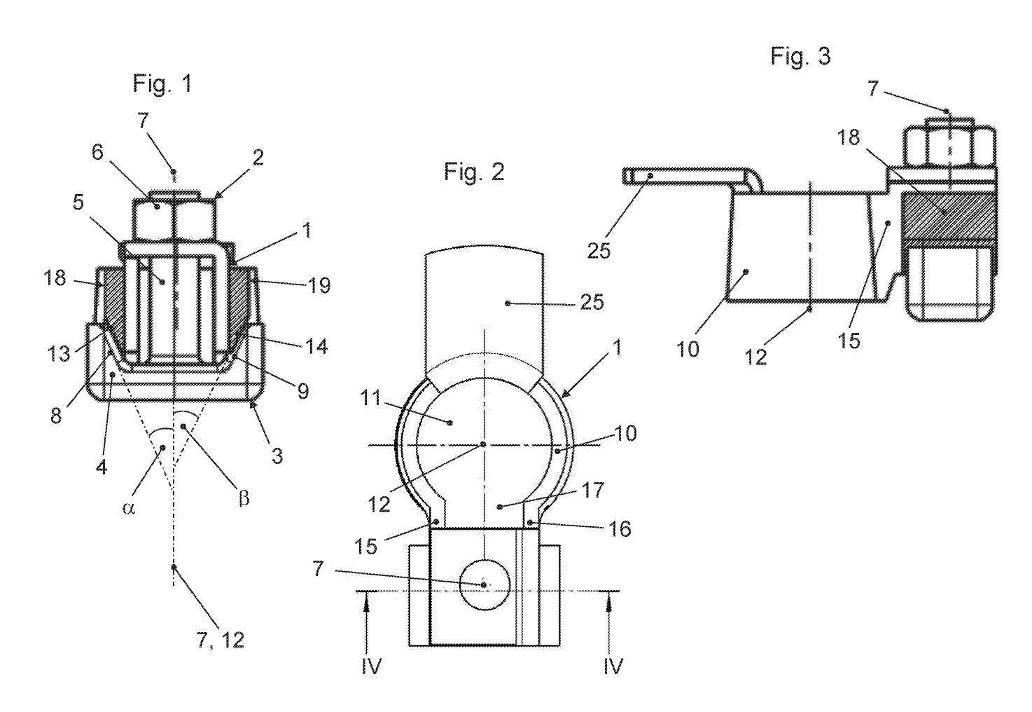

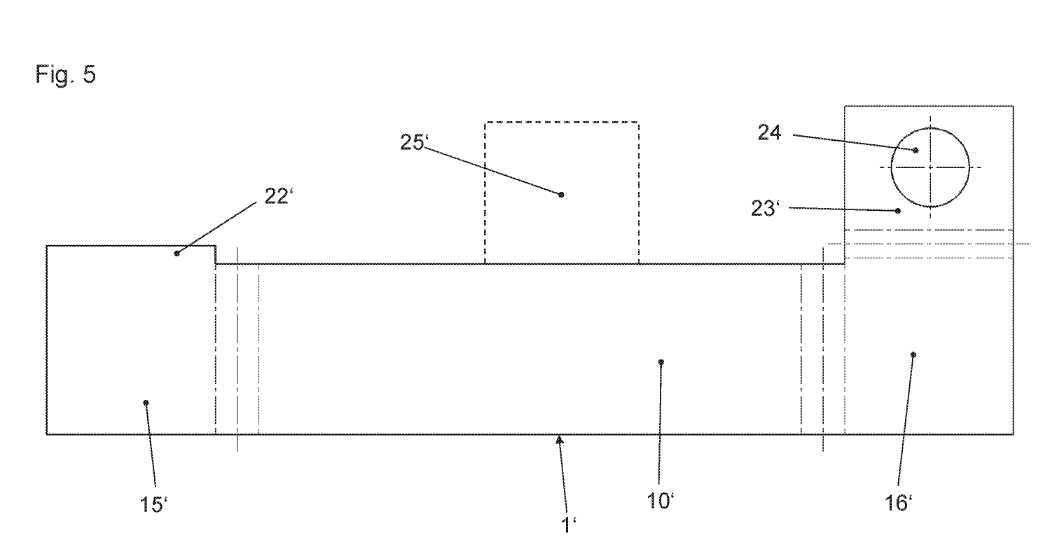

The embodiment of a battery clamp depicted in FIGS. 1 through 4 includes a single-piece punch-bent component (1) as well as fasteners (2). The fasteners (2) consist of a screw (3) with a head (4) and a threaded section (5) as well as a nut (6) into which the threaded section (5) can be screwed. The cylinder axis (7) of the threaded section (5) has been drawn in FIG. 1, FIG. 2 and FIG. 3.

The punch-bent component (1) consists, at least in sections, of an electrically conductive material (particularly metal) such as copper or a copper alloy.

On the side of the head (4) facing the threaded section (5), there are two angled surfaces (8, 9) positioned opposite each other, which, with the axial direction of the threaded section (5) or its cylinder axis (7), enclose an angle α. which lies between 10° and 40°, especially between 20° and 30° in the depicted embodiment (see FIG. 1). FIG. 1 shows that the angled surfaces (8, 9) are positioned on the inner side of the edge of the head (4) surrounding the threaded section (5).

The punch-bent component (1) includes a holder (10), which can be pushed onto a non-depicted conical pole of a battery. Here, the holder (10) is designed from a section surrounding more than 270° and preferably more than 300° of the punch-bent component (1), which leaves an inner conical space (11) free for the (normally) conical pole. The surrounding section has the shape of the surface of a partially truncated cone. The cone axis (12) of the inner conical space (11) of the holder (10) extends parallel to the cylinder axis (6) of the threaded section (5) of the screw (3) (see FIG. 2).

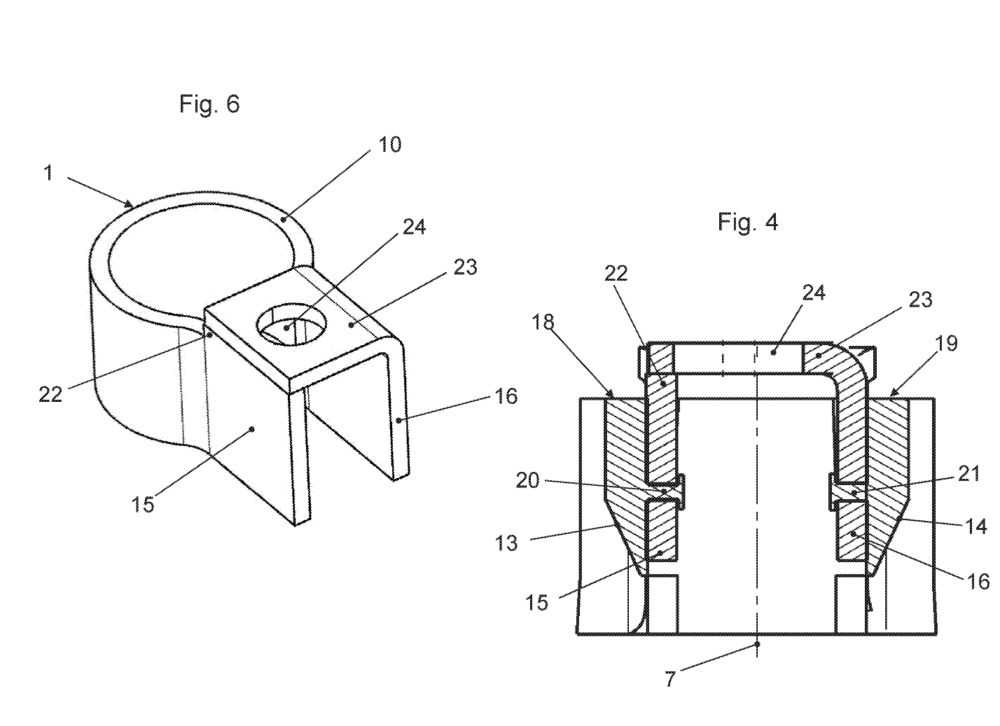

As clamps, the battery clamp also includes as two clamping elements (18, 19) positioned on two sides of the punch-bent component (1) facing away from each other. Each of these clamping elements (18, 19) features an angled surface (13, 14). These angled surfaces are positioned on outer sides of the clamping elements (18, 19) facing away from the punch-bent component (1) (see FIG. 1 and FIG. 4). The angled surfaces (13, 14) together with the cylinder axis (7) of the threaded section (5) or with the cone axis (12) of the inner conical space (11) of the holder (10) enclose an angle B, which lies between 10° and 40°, especially between 20° and 30° in the illustrated embodiment (see FIG. 1).

The clamping elements (18, 19) can, at least in some sections, consist of metal or other suitable materials.

The clamping elements (18, 19) are positioned on limbs (15, 16) which extend away from the holder (10) (see FIG. 2 for example). The holder (10) is open on one side, as it is formed by the section of the punch-bent component (1) encircling an approx. 300° area (as an example). From the end areas of the single-side opening (17) of the holder (10), the limbs (15, 16) extend in the same direction (for example, downward as shown in FIG. 2).

FIG. 4 shows that one connection element (20, 21), preferably one mushroom-head pin, extends from each of the clamping elements (18, 19), and connects one of the clamping elements (18, 19) with one of the limbs (15, 16). In particular, the connection element (20, 21) here extends inward and passes through the respective limb (15, 16).

The connection between the clamping elements (18, 19) and the limbs (15, 16) can be a stamp in each case, created during the punching of the punch-bent component (1).

There exists the possibility that other means of connection can be used in place of the connection elements. This applies in particular to the stamped elements. For example, the clamping elements (18, 19) could also be glued to the limbs (15, 16) of the punch-bent component (1).

FIG. 5 shows a punching blank (1′) of a punch-bent component (1) of one of the inventive battery clamps featuring fundamental components of the invention after punching but before bending. In the middle of this punching blank (1′), the section (10′) that is to become the holder (10) is visible. It is brought into the shape of a partially truncated cone surface through the bending process. It is at this section (10′) where the limbs (15, 16) connect on the left and right in FIG. 5. In FIG. 5, each of the sections (15′, 16′) of the punching blank (1′) that are to become the limbs (15, 16) extend upward at their end facing away from the center section (10′).

It can also be seen from FIG. 5 that the sections (22′, 23′) in the punching blank (1) extend upward from the sections (15′, 16′) that are to become the limbs (15, 16). The section on the right (23′) in FIG. 5 is, similarly to FIG. 6, clearly bent inward by approximately 90° during the bending process so that it forms a holding section (23) for the fasteners (2). The holding section (23) here overlaps the upward-extending end of the section (22) corresponding to the section (22′) of the punching blank (1′), which has not been bent. The holding section (23) of the limb (16) on the right in FIG. 6 has an opening (24) (see also FIG. 5). The threaded section (5) of the screw (3) can extend through the opening (24) (see also FIG. 1 and FIG. 4).

On the side of the recess (10) facing away from the limbs (15, 16), there is a connection section (25) positioned on the recess for a non-illustrated cable or a non-illustrated battery sensor, which is particularly a part of the single-part punch-bent component (1) (see FIG. 2, FIG. 3 and FIG. 4 in particular). The section (25′) of the punching blank (1′) that is to become this connection section (25) is simply represented by a dashed line in FIG. 5 and omitted from FIG. 6. After the punch-bent component has been bent, the connection section (25) extends in the direction facing away from the limbs (15, 16) (see FIG. 3).

Once the components of the battery clamp have been assembled as depicted in FIG. 1 and FIG. 3, the head (4) of the screw (3) is located on the bottom while the threaded section (5) extends upward from the head (4). The punch-bent component (1) together with the clamping elements (18, 19) are supported on the top side of the head (4) facing the threaded section (5). In particular here, the outward-facing angled surfaces (13, 14) of the clamping elements (18, 19) make contact with the inward-facing angled surfaces (8, 9) of the head (4) (see FIG. 1 and FIG. 4 in particular).

The threaded section (5) extends through the opening (24) and upward into the nut (6) lying on the top side of the holding section (23) that the opening (24) is part of.

If the holder (10) has been pushed onto the pole of a battery, tightening the nut (6) onto the threaded section (5) can move the nut (6) downward in FIG. 1. This causes the angled surfaces (13, 14) of the clamping elements (18, 19) to slide upward and downward along the angled surfaces (8, 9) of the head (4) of the screw (3). This inward movement of the angled surfaces (13, 14) causes the limbs (15, 16) to move toward each other as well. This reduces the diameter of the holder (10) and clamps the pole of the battery in the holder (10).

### REFERENCE

1 Punch-bend Component
1′ Punching Blank
2 Fasteners
3 Screw
4 Head of Screw (3)
5 Threaded Section of the Screw (3)
6 Nut
7 Cylinder Axis of the Threaded Section (5)
8 Angled Surface on the Head (4) of the Screw (3)
9 Angled Surface on the Head (4) of the Screw (3)
10 Holder
10′ Section of the Punching Blank (1′) that is to become the Holder (10)
11 Conical Space in the Holder (10)
12 Cone Axis of the Conical Space (11)
13 Angled Surface on the Clamping Element (18)
14 Angled Surface on the Clamping Element (19)
15 Limb of the Punch-bent Component (1)
15′ Section of the Punching Blank (1′) that is to become the Limb (15)
16 Limb of the Punch-bent Component (1)
16′ Section of the Punching Blank (1′) that is to become the Limb (16)
17 One-sided Opening of the Holder (10)
18 Clamping Element
19 Clamping Element
20 Connection element on the clamping element (18)
21 Connection element on the clamping element (19)
22 Section of the Punch-bent Component (1)
22′ Section of the Punching Blank (1′) that is to become the Section (22)
23 Holding Section
23′ Section of the Punching Blank (1′) that is to become the Holding Section (23)
24 Opening in the Holding Section (23)
25 Connection section
25′ Section of the Punching Blank (1′) that is to become the Connection Section (25)

1. A battery clamp comprising:
a punch-bent component on which a holder is formed, wherein the holder is applied to a battery pole in an application direction;
fasteners for clamping the holder onto the pole of the battery, where the fasteners are engaged in in the application direction of the holder;
clamps that interact with the fasteners to clamp the holder on the pole of the battery;
wherein the clamps include at least one clamping element, and the clamping element is at least one of connected to the punch-bent component and makes contact with the punch-bent component.

2. The battery clamp in accordance with claim 1, wherein the battery clamp is a single-part punch-bent component with the exception of the fasteners and at least one clamping element.

3. The battery clamp in accordance with claim 1, wherein the at least one clamping element includes an angled surface enclosing an angle (β) not equal to 0° or to 90° relative to the application direction.

4. The battery clamp in accordance with claim 1, wherein the fasteners include at least one angled surface enclosing an angle not equal to 0° or to 90° relative to the application direction.

5. The battery clamp in accordance with claim 1, wherein the battery clamp includes two clamping elements each having one angled surface enclosing an angle (β) not equal to 0° or to 90° relative to the application direction, where both clamping elements are preferably positioned on sides of the punch-bent component facing away from each other, and wherein the fasteners include two angled surfaces enclosing an angle not equal to 0° or to 90° relative to the application direction, where both angled surfaces of the fasteners are preferably positioned opposite each other.

6. The battery clamp in accordance with claim 4, wherein the angled surface of the at least one clamping element makes contact with the minimum of one angled surface of the fasteners, interacting with said surface to clamp the holder on the pole of the battery.

7. The battery clamp in accordance with claim 4, wherein the fasteners include a screw with a head and a threaded section as well as a nut.

8. The battery clamp in accordance with claim 7, wherein the minimum of one angled surface of the fasteners is positioned on the head of the screw or on the nut.

9. The battery clamp in accordance with claim 2, wherein the holder is open on the side, in particular in a direction vertical relative to the application direction, or has an opening, where the punch-bent component has two limbs connecting to the opening of the holder and extending away from the holder.

10. The battery clamp in accordance with claim 9, wherein the at least one clamping element is positioned against one of the limbs of the punch-bent component, where one clamping element is positioned on each of the two limbs.

11. The battery clamp in accordance with claim 10, wherein the at least one clamping element is firmly connected to one of the limbs (15, 16) of the punch-bent component through stamping.

12. The battery clamp in accordance with claim 9, wherein the punch-bent component includes at least one holding section for the fasteners.

13. The battery clamp in accordance with claim 12, wherein the at least one holding section of the punch-bent component is positioned on one of the limbs.

14. The battery clamp in accordance with claim 9, wherein the battery clamp includes a connection section for a cable or a battery sensor particular is included in the punch-bent component (1) design, where the connection section on the side facing away from the limbs protrudes away from the holder in the direction facing away from the limbs.

15. A method for manufacturing a battery clamp in accordance with claim 2, wherein the at least one clamping element is connected to the punch-bent component in the course of being punched and/or bent.

16. The battery clamp of claim 3, wherein the angle (β) is between 10° and 40°.

17. The battery clamp of claim 3, wherein the angle (B) is between 20° and 30°.

18. The battery clamp of claim 4, wherein the angle is between 10° and 40°.

19. The battery clamp of claim 4, wherein the angle is between 20° and 30°.
